(19) United States
(12) Patent Application Publication
(10) Pub. No.: US 2011/0255769 A1
(43) Pub. Date: Oct. 20, 2011

(54) MACHINE PERFORMANCE TESTING METHOD AND DEVICE

(75) Inventors: Klaus-Peter GALUSCHKI, Berlin (DE); Yi Hua Gong, Shanghia (CN); Yu Hu, Shanghai (CN); Ming Shen, Shanghai (CN)

(73) Assignee: Siemens Aktiengesellschaft, Munich (DE)

(21) Appl. No.: 13/086,807

(22) Filed: Apr. 14, 2011

(30) Foreign Application Priority Data
Apr. 15, 2010 (CN) 201010150070.7

(51) Int. Cl. G06K 9/00; H04N 1/04

(52) U.S. Cl. 382/141; 358/474

(57) ABSTRACT

A transparent panel is used to acquire a test sample from a machine to be tested; where the test sample includes at least one object placed on the transparent panel by the machine to be tested. A scanning device is used to scan the transparent panel to obtain image data and a computing device is used to determine the operation accuracy of the machine to be tested according to the image data from the scanning device. These devices may be used for machine performance testing and acquiring an image of the test sample.

### CROSS REFERENCE TO RELATED APPLICATIONS

This application is based on and hereby claims priority to Chinese Patent Application No. 201010150070.7 filed on Apr. 15, 2010, the contents of which are hereby incorporated by reference.

### BACKGROUND

The method described below relates to the technical field of electronic assembly and, particularly, to a machine performance testing method. Also described are a machine performance testing device and a device for acquiring an image of a test sample applied in the surface mount technology (SMT) industry.

Surface mount technology (also known as SMT) is currently the most popular technology and process in the electronic assembly industry, and it is suitable for assembling electronic products with high density, small size, and light weight. In the technology, the size and weight of the SMT components are only about one tenth of that of the traditional plug-in mounting components, and after employing the surface mount technology, the size of the electronic products can generally be reduced by 40-60% and the weight thereof reduced by 60-80%.

In SMT, in order to ensure the accuracy of the machine operation, a very important aspect is to test the machine performance. For example, the performance of a piece of equipment, such as the positioning accuracy of a placement machine, a printer and the like needs to be tested; when testing a placement machine, it is necessary to measure the position accuracy when the placement machine places an assembly on a certain board; and when testing a printer, it is necessary to measure the position accuracy when the printer prints a solder paste or glue on a certain board.

Currently, there are two methods for testing the machine performance:

I. One method is by using a coordinate measurement machine (CMM). However, in SMT, a large amount of assemblies to be measured generally are distributed on a board with a relatively small area, and it is necessary for the coordinate measurement machine to measure each assembly one by one. However, in order to ensure the testing accuracy, such coordinate measurement machine cannot be moved at a high frequency, and in turn the measurement efficiency is too low. Moreover, such a measurement machine is very expensive.

II. The other method is to use a specific measurement machine based on a charge-coupled device camera (CCD Camera). However, the disadvantages of this method are as follows: 1. such measurement machines cannot automatically adjust the focus of the CCD camera, so they depend on experience of the user to a great extent; 2. such measurement machines need to measure the assemblies one by one, however, a large number of assemblies usually need to be measured to determine the machine performance in the practical SMT applications, therefore the measurement efficiency of such measurement machines is too low; 3. their size is too big to be used conveniently by users; and 4. such measurement machines are also relatively expensive.

### SUMMARY

To solve the above-mentioned technical problems, a machine performance testing method, a machine performance testing device and a device for acquiring an image of a test sample are described. A machine performance test in the SMT industry can be achieved with a relatively high efficiency and with relatively low costs by employing the method and device described below.

A machine performance testing device includes a transparent panel, a scanning device, and a computing device; whereby the transparent panel is used to acquire a test sample from a machine to be tested, where the test sample includes at least one object placed on the transparent panel by the machine to be tested; the scanning device is used to scan the transparent panel to obtain image data; and the computing device is used to determine the operation accuracy of the machine to be tested according to the image data from the scanning device.

A machine performance testing method includes acquiring a test sample from a machine to be tested by using a transparent panel, where the test sample includes at least one object placed on the transparent panel by the machine to be tested; scanning the transparent panel to obtain image data; and determining the operation accuracy of the machine to be tested according to the image data.

A device for acquiring an image of a test sample includes the above-mentioned transparent panel and the above-mentioned scanning device.

### BRIEF DESCRIPTION OF THE DRAWINGS

The above-mentioned and other features and advantages will be made more apparent to those skilled in the art by the exemplary embodiments described in detail below with reference to the accompanying drawings, in which:

FIG. 1 is a schematic diagram of a machine performance testing device according to an embodiment;

FIG. 2 is a schematic diagram of the implementation principles of a device for acquiring an image of a test sample according to an embodiment;

FIG. 3 is a flowchart of a machine performance testing method according to an embodiment;

FIG. 4 is a schematic diagram of an example of the offset measured according to an embodiment;

FIG. 5 is a flowchart of a method for testing the assembly accuracy of a placement machine according to an embodiment;

FIG. 6 is a flowchart of a method for testing the offset of a printer according to an embodiment; and

FIG. 7 is a flowchart of a method for testing the printing accuracy of a printer according to an embodiment.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

Reference will now be made to the preferred embodiments, examples of which are illustrated in the accompanying drawings, wherein like reference numerals refer to like elements throughout. It should be understood that the particular embodiments described herein are only for the explanation and are not to limit the present invention.

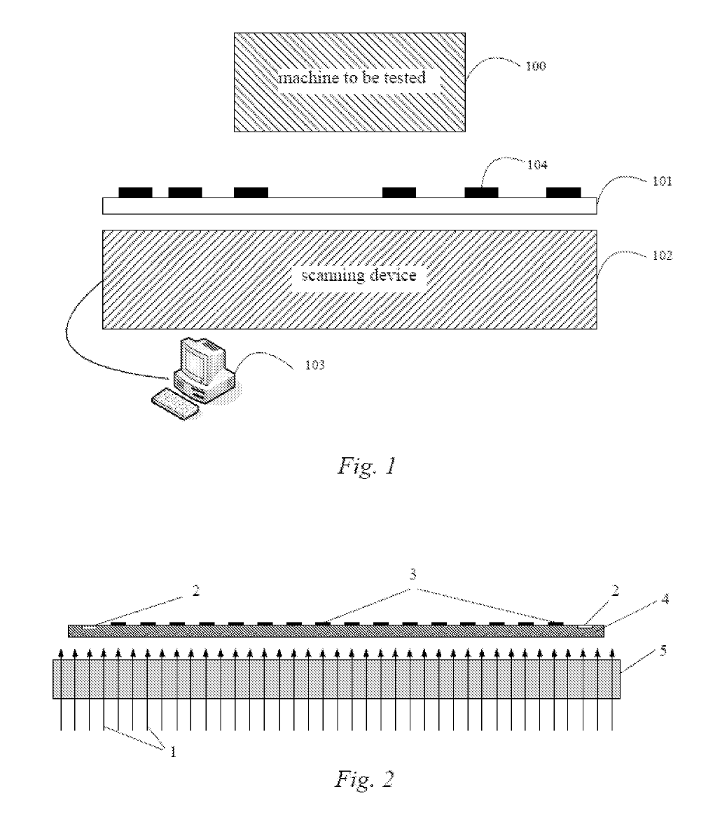

FIG. 1 is a schematic diagram of a machine performance testing device according to an embodiment. As shown in FIG. 1, this machine performance testing device includes a transparent panel 101, a scanning device 102 and a computing device 103, where the transparent panel 101 is used to acquire a test sample from a machine 100 to be tested. When testing the performance of a machine, the transparent panel 101 will be placed at a suitable position so that the machine 100 to be tested can put an object 104 handled by it on the transparent panel 101 (for example, a placement machine to be tested places an assembly on the transparent panel 101, or a printer to be tested prints a solder paste or glue on the transparent panel 101). Here, this embodiment is suitable for an SMT machine (such as a placement machine or a printer, etc.), which SMT machine needs to place an object handled by it on a board in its normal operation, and when the SMT machine is tested according to the embodiment, as for the SMT machine, the action with which it places the object 104 handled by it on the transparent panel 101 corresponds to a normal operation by it such as a placement or printing operation, so that a test sample is acquired on the transparent panel 101, which test sample includes each object 104, such as an assembly, solder paste or glue, placed on the transparent panel 101 by the machine 100 to be tested and can indicate the position of the objects 104. Here, the transparent panel 101 can be a transparent glass panel or a transparent panel of other materials suitable for acquiring test samples from the SMT machine.

The scanning device 102 is used to scan the transparent panel 101 in order to obtain image data, wherein, since the test sample has been acquired on the transparent panel 101, apparently the image data obtained by the scan should be able to indicate the positional information of the objects 104 in the test sample. Here, the scanning device 102 can be various commonly-used scanners, or any scanning device that includes the core component (i.e., optical imaging component) of a currently available scanner. The implementation principles for the scanning device in obtaining the image data by scanning are not the contents concerned in this method and will not be described in detail here.

The computing device 103 is used to determine the operation accuracy of the machine 100 to be tested according to the image data from the scanning device 102. In this case, the computing device 103 first simulates a current image of the transparent panel 101 according to the image data from the scanning device 102, computes the offset between the actual position and a respective ideal position of each object 104 in the test sample currently acquired on the transparent panel 101 according to the simulated image, and then determines the operation accuracy of the machine 100 to be tested according to the computed offset of each object 104. Here, such a computing device 103 can be any device capable of running certain software to complete the computation and/or statistical functions, for example, it can be implemented by employing a general-purpose personal computer (PC). Such a computing device 103 can be implemented as a hardware device, and it can also be a virtual device implemented by way of software.

In this case, to determine the offset of the actual position and the respective ideal position of each object 104 in the test sample, a series of data points can be set on the transparent panel 101 to establish a coordinate system to indicate the actual position of the object 104 on the transparent panel 101. In particular, two or three data points can be set on the transparent panel 101; for example, these data points can be set on the corners of the transparent panel 101; for example, one data point can be set on each of two adjacent corners among the four corners of the transparent panel 101, or one data point can be set on each of three corners among the four corners of the transparent panel 101. In this case, those skilled in the art can know that the origin of a coordinate system can be determined according to several data points, so that the coordinate of the object 104 in this coordinate system can be determined according to the relative distance between the object 104 and the origin, thus this coordinate system can be used to represent the actual position of the object 104. Here, the same coordinate system is used to represent the actual position and the ideal position of the object 104, and then the offset can be determined according to the coordinate of the actual position and the coordinate of the predetermined ideal position.

Based on the machine performance testing device provided by the above-mentioned embodiment, an embodiment of a device for acquiring an image of a test sample from a machine to be tested can be provided and operation accuracy of the machine to be tested can be determined according to the image data of the test sample acquired by this device. This device for acquiring an image of a test sample at least includes the transparent panel 101 and the scanning device 102 shown in FIG. 1.

FIG. 2 is a schematic diagram of the implementation principles of a device for acquiring an image of a test sample according to an embodiment. As shown in FIG. 2, there are two data points 2 set on the front surface of the transparent panel 4 (setting the upward surface when the transparent panel 4 is horizontally placed as the front surface), and there are several objects 3 (such as an assembly or a solder paste). The scanning device is placed under the transparent panel 4, and when the scanning device is scanning, its scanning light source is stripe-shaped and radiates several lines of light rays 1 perpendicular to the transparent panel 4, and these light rays 1 radiate onto the reverse side of the transparent panel 4 and can scan the image information of the whole transparent panel 4 progressively, and the light rays 1 radiating onto the transparent panel 4 pass through a very narrow gap after having been reflected and then form a transverse beam 5. This beam 5 passes through a set of reflectors, is focused by a optical lens and goes into a spectroscope, passes through a prism and a three-color filter of red, green and blue to obtain three color beams of red, green and blue (RGB), with these three color beams respectively radiating onto its respective CCD, then the CCDs convert the RGB beams into analog electronic signals, and the analog electronic signals are converted into digital electronic signals by an analog/digital (A/D) converter. By then, the optical signals reflecting the image of the transparent panel 4 have been transformed into binary digital electronic signals. The digital electronic signals can be simulated to form an image of the transparent panel 4 after having been processed by the computing device. Here, since the embodiment uses the transparent panel, the image of the transparent panel obtained by the scan can at the same time reflect the image of each object on the transparent panel, then this image can be used to determine the positional information of each object.

Based on the machine performance testing device provided by the above-mentioned embodiment, an embodiment of a machine performance testing method can be provided.

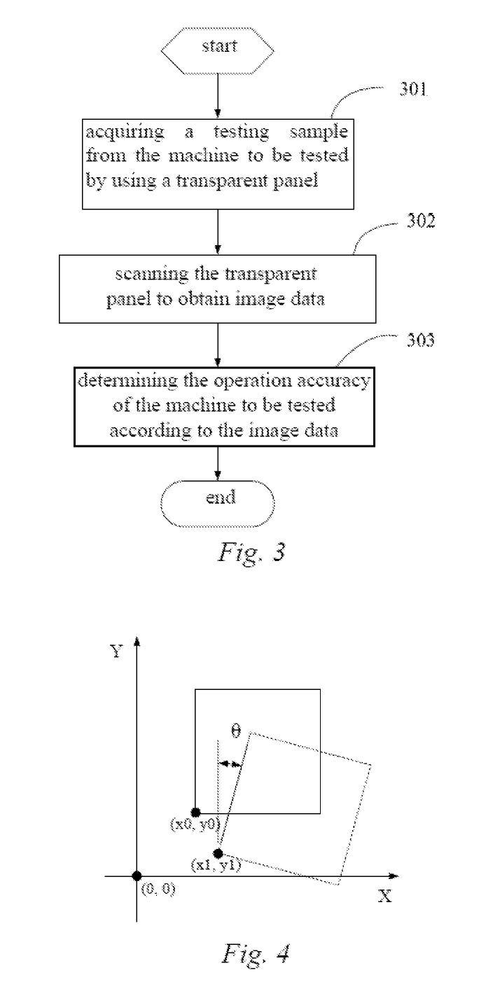

FIG. 3 is a flowchart of a machine performance testing method according to an embodiment. In this embodiment, the method is applied to the device shown in FIG. 1. As shown in FIG. 3, this method has the following steps:

Step 301: a test sample is acquired from the machine 100 to be tested by using the transparent panel 101. Such a test sample includes the objects 104, such as an assembly or a solder paste, etc., placed on the transparent panel 101 by the machine 100 to be tested and can represent the position of each object 104.

Step 302: the transparent panel 101 is scanned by the scanning device 102 to obtain image data. In this case, the image data obtained by the scan can indicate the positional information of each object 104 in the test sample acquired on the transparent panel 101.

Step 303: the operation accuracy of the machine 100 to be tested is determined by the computing device 103 according to the image data from the scanning device 102. In this case, the computing device 103 first simulates a current image of the transparent panel 101 according to the image data from the scanning device 102, computes the offset between the actual position and the respective ideal position of each object 104 in the test sample currently acquired on the transparent panel 101 according to the simulated image, and then determines the operation accuracy of the machine 100 to be tested according to the computed offset of each object 104.

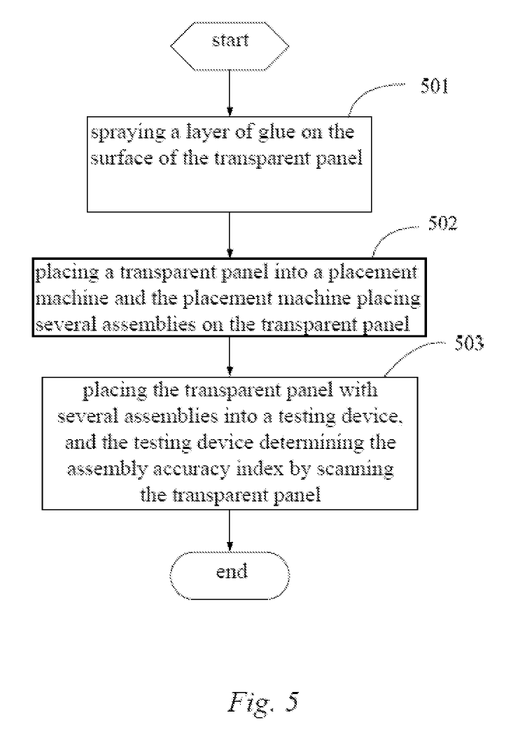

In this case, when computing the offset between the actual position and the respective ideal position of each object 104, the computed offset can include any one of the horizontal offset, the vertical offset, and the angle offset of the object 104, or any combination thereof. For example, the computed offset may not only include the offsets of the object 104 in the horizontal direction and the vertical direction but also includes the angle offset of the object 104. In particular, FIG. 4 is a schematic diagram of an example of the offset measured according to an embodiment. As shown in FIG. 4, in the X-Y two dimensional coordinate system determined according to the data points, the ideal position of one certain point of a square object is (x0, y0), while in the test sample acquired on the transparent panel, the actual position of this point of this square object is (x1, y1). By comparing the coordinate of the ideal position of the square object and the coordinate of its actual position, the offset of the square object in the horizontal direction is determined to be x1−x0, and its offset in the vertical direction be y1−y0. At the same time, the angle offset of the square object can also be determined to be θ by comparing the image of the square object at the ideal position and the image at the actual position obtained by the scan. In this way, a user can obtain the operation accuracy of the machine expressed by the parameters (x, y, θ).

By employing the device and method provided by the above-mentioned embodiments, a user can efficiently obtain the operation accuracy of an SMT machine. Generally, the test can be carried out according to the embodiments while performing the daily maintenance to the SMT machine. The test results can be obtained in about half an hour and compared with the various existing testing techniques. The testing efficiency is improved significantly. In particular, when performing a test according to the embodiments, the offsets of several objects on the transparent panel can be measured in one scan, while in the currently available technical solutions only one object's offset can be measured in one scan. In addition, the device and method provided by the embodiments can also ensure the relatively high testing accuracy with low costs. In particular, the scanning device used in the embodiments is based on the scanning technologies which have been known and are widely used now, and their resolutions are far higher than that of the CCD camera but the costs are less than the CCD camera, and this means that the testing accuracy of the embodiments is far higher than the testing accuracy of the related art employing the CCD camera and its implementation costs are very low. In addition, the embodiments are relatively convenient in use, it is not necessary to adjust the focus or specific optical system of the scanning device during the test, and compared with the currently available testing devices, the testing device provided by the embodiments is small in size and light in weight, and is very suitable for high frequency measurement.

Hereinbelow, the testing method provided by an embodiment will be further described in further conjunction with practical application scenarios.

FIG. 5 is a flowchart of a method for testing the assembly accuracy of a placement machine according to an embodiment. As shown in FIG. 5, this method has the following steps:

Step 501: a layer of glue is sprayed on the surface of a transparent panel.

Step 502: the transparent panel is placed into the placement machine, with the placement machine disposing several assemblies on the transparent panel.

In this case, when testing the performance of the placement machine, it is necessary to spray a layer of glue on the transparent panel to fix the assemblies, thus the position of the assemblies can be measured accurately.

After the above-mentioned steps 501 and 502, a test sample is acquired from the placement machine by using the transparent panel.

Step 503: the transparent panel with several assemblies is placed into a testing device according to an embodiment, with this testing device determining the assembly accuracy index of the placement machine by scanning the transparent panel.

During the course of this method, as with the implementation principles of the previously mentioned testing device and method, the scanning device in this testing device first scans the transparent panel and outputs the image data to the computing device, and the computing device simulates a current image of the transparent panel according to this image data, computes the offset between the actual position and the respective ideal position of each assembly on the transparent panel according to the simulated image, and then determines the assembly accuracy index of the placement machine according to the offset of each assembly. Here, the offsets of a certain number of assemblies can be counted statistically to obtain the assembly accuracy index of the placement machine, and according to a practical application scenario, it can be set that only the offsets of a part of or all of the assemblies in the test sample currently acquired are counted statistically to obtain the assembly accuracy index, or it can also be set that the offsets of a part of or all of the assemblies in several test samples already acquired are counted statistically to obtain the assembly accuracy index; this assembly accuracy index may include the complex process capability index (CPK) and/or process performance index (PPK), etc., and the particular computing method of the assembly accuracy index is not of concern, and will not be described in detail here.

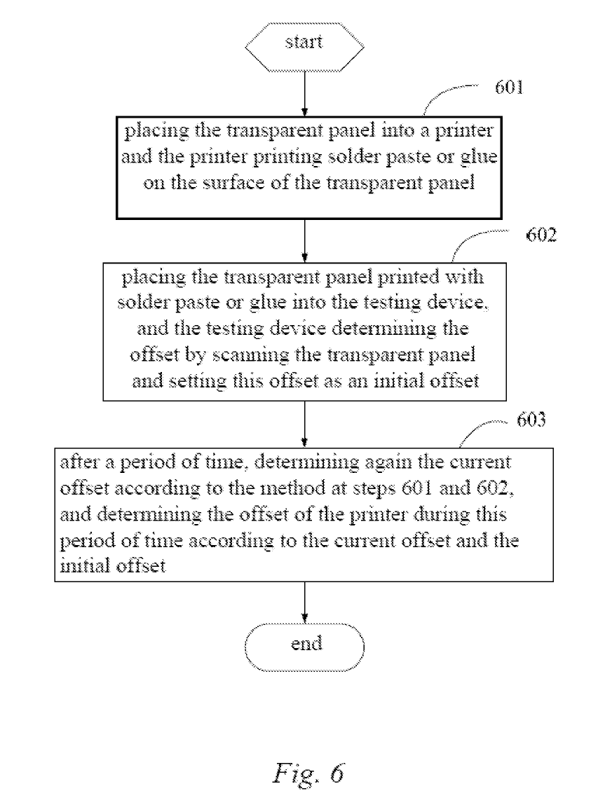

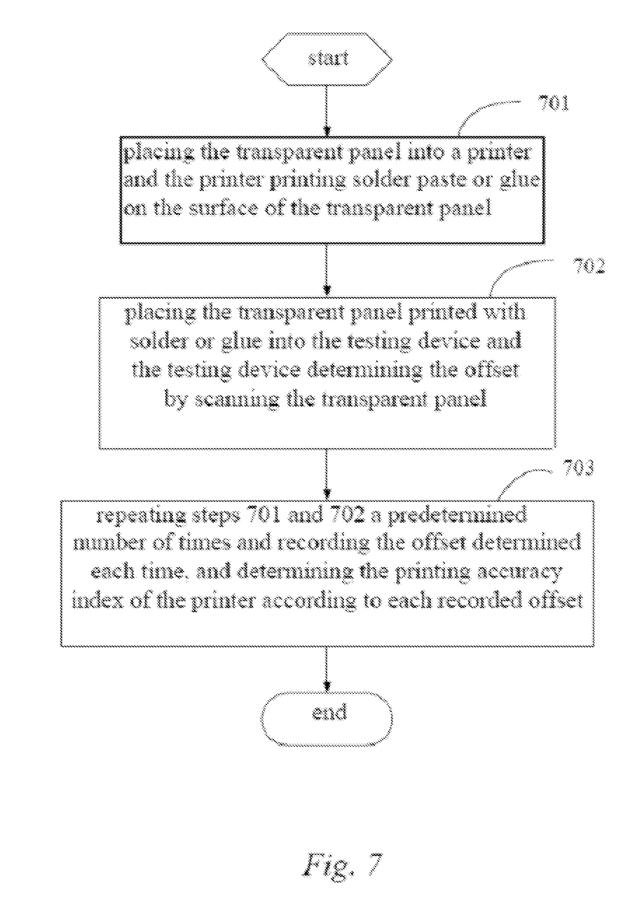

FIG. 6 is a flowchart of a method for testing the offset of a printer according to an embodiment. As shown in FIG. 6, this method has the following steps:

Step 601: a transparent panel is placed into a printer, and a solder paste or glue is printed on the transparent panel using a template suitable for the transparent panel. Here, if glue is printed on the transparent panel, then the glue should possess a certain property so that the scanning device can scan the image of the printed glue when scanning the transparent panel. After step 601, a test sample is acquired from the printer using the transparent panel.

Step 602: the transparent panel printed with the solder paste or glue is placed into the testing device according to the embodiment, and the testing device determines the offset of the solder paste or glue printed at each place in the test sample acquired in step 601 by scanning the transparent panel and setting the offset as an initial offset.

During the course of this method, as with the implementation principles of the previously mentioned testing device and method, the scanning device in this testing device first scans the transparent panel and outputs the image data to the computing device, and the computing device simulates a current image of the transparent panel according to this image data and computes the offset of the actual position and the respective ideal position of the solder paste or glue printed at each place on the transparent panel according to the simulated image. Here, the ideal position of the solder paste or glue complies with the template for printing the solder paste or glue.

Step 603: after a period of time, the offset of the solder paste or glue printed at each place in the test sample currently acquired from the printer is again determined according to the method of steps 601 and 602, and then the amount of the misalignment of the printer during this period of time is determined according to the offset currently determined and the initial offset at step 602, i.e., the offset of the printer during this period of time.

In this case, the offset of the printer is generally measured by using the testing device provided by an embodiment while performing the repair/maintenance operation, so that in the flow chart shown in FIG. 6, steps 601 and 602 can be performed during the initial repair/maintenance operation, and step 603 can be performed during a subsequent repair/maintenance operation, thus the offset of the printer can be determined between a certain repair/maintenance operation and the initial one, and the printer can be adjusted according to this offset, so that the printer can be restored to the state corresponding to the initial offset during the initial repair/maintenance operation.

FIG. 7 is a flowchart of a method for testing the printing accuracy of a printer according to an embodiment. As shown in FIG. 7, this method has the following steps:

Step 701: a transparent panel is placed into the printer, and solder paste or glue is printed on the transparent panel using a template suitable for the transparent panel. After step 701, a test sample is acquired from the printer by using the transparent panel.

Step 702: the transparent panel printed with the solder paste or glue is placed into the testing device according to the embodiments, and the testing device determines the offset of the solder paste or glue printed at each place in the test sample acquired at step 701 by scanning the transparent panel and recording each offset currently determined.

Here, the implementation principles of steps 701 and 702 are the same as those of the above-mentioned steps 601 and 602.

Step 703: steps 701 and 702 are repeated a predetermined number of times, for example, steps 701 and 702 are repeated twenty times, and the determined offset is recorded when steps 701 and 702 are performed each time. Finally, the printing accuracy index of the printer is determined according to each recorded offset. In this case, the method for determining the printing accuracy index according to each offset is the same as the method for determining the assembly accuracy index at step 503, which will not be described redundantly.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A machine performance testing device for testing a machine, comprising:
a transparent panel acquiring a test sample from the machine to be tested, the test sample including at least one object placed on said transparent panel by the machine to be tested;
a scanning device scanning said transparent panel to obtain image data; and
a computing device determining operation accuracy of the machine to be tested according to the image data from said scanning device.

2. The testing device according to claim 1, wherein said computing device generates a simulated image of said transparent panel according to the image data from said scanning device, determines the offset between an actual position and a respective ideal position of each object in the test sample currently acquired on said transparent panel according to the simulated image, and then determines the operation accuracy of the machine to be tested according to the offset of each object.

3. The testing device according to claim 1, wherein when the machine to be tested is a placement machine, the at least one object in the test sample includes an assembly placed on the transparent panel and when the machine to be tested is a printer, the at least one object in the test sample includes solder paste or glue printed on the transparent panel.

4. A machine performance testing method, comprising:
acquiring a test sample from a machine to be tested, using a transparent panel; the test sample including at least one object placed on the transparent panel by the machine to be tested;
scanning the transparent panel to obtain image data; and
determining operation accuracy of the machine to be tested according to the image data.

5. The testing method according to claim 4, wherein said determining the operation accuracy of the machine to be tested according to the image data comprises:
obtaining a simulated image of the transparent panel according to the image data;
determining an offset between an actual position and a respective ideal position of each object in the test sample currently acquired on the transparent panel according to the simulated image;
determining the operation accuracy of the machine to be tested according to the offset of each object.

6. The testing method according to claim 5, wherein said determining the operation accuracy of the machine to be tested according to the offset of each object comprises one of:
determining the operation accuracy according to offsets of at least a part of objects in the test sample currently acquired; and
determining the operation accuracy according to the offsets of at least a part of the objects in a plurality of test samples already acquired.

7. The testing method according to claim 6, wherein the offset is at least one of a horizontal offset, a vertical offset and an angle offset.

8. A machine performance testing method for testing a placement machine for assembly accuracy, said testing method comprising:
acquiring a test sample from the placement machine using a transparent panel on which a layer of glue is sprayed, the transparent panel is placed into the placement machine, and at least one assembly is placed on the transparent panel by the placement machine;
scanning the transparent panel to obtain image data;
simulating an image of the transparent panel according to the image data;
determining an offset between an actual position and a respective ideal position of each assembly in the test sample currently acquired on the transparent panel;
counting statistically at least one of offsets of at least a part of assemblies in the test sample currently acquired and the offsets of at least a part of the assemblies in a plurality of test samples already acquired; and
computing the assembly accuracy of the placement machine based on said counting.

9. A machine performance testing method for testing an offset of a printer; said testing method comprising:
during an initial stage, acquiring a first test sample from the printer using a transparent panel by
placing the transparent panel the printer,
printing a solder paste or glue on the transparent panel using a template suitable for the transparent panel,
scanning the transparent panel to obtain first image data;
obtaining a first simulated image of the transparent panel based on the first image data,
determining an initial offset between an actual position and a respective ideal position of the solder paste or glue at each place printed on the transparent panel according to the first simulated image, and
recording the initial offset; and
after a period of time, acquiring a second test sample from the printer using the transparent panel by
scanning the transparent panel to obtain second image data,
obtaining a second simulated image of the transparent panel according to the second image data, and
determining a subsequent offset between the actual position and the respective ideal position of the solder paste or glue printed at each place on the transparent panel according to the second simulated image; and
comparing the subsequent offset with the initial offset to obtain a current offset of the printer during this period of time.

10. A machine performance testing method for testing printing accuracy of a printer; said testing method comprising:
acquiring a test sample from the printer using a transparent panel, where the transparent panel is placed into the printer and a solder paste or glue is printed on the transparent panel by using a template suitable for the transparent panel;
scanning the transparent panel to obtain image data;
obtaining a simulated image of the transparent panel according to the image data;
determining an offset between an actual position and a respective ideal position of the solder paste or glue printed at each place on the transparent panel according to the simulated image;
recording the offset;
repeating said acquiring, scanning, obtaining, determining and recording a predetermined number of times;
counting statistically each offset recorded; and
computing the printing accuracy of the printer based on said counting.

11. A device for acquiring an image of a test sample from a machine to be tested, comprising:
a transparent panel acquiring a test sample from the machine to be tested, the test sample including at least one object placed on the transparent panel by the machine to be tested; and
a scanning device scanning said transparent panel to obtain image data of the image of the test sample.
